(19) United States
(12) Patent Application Publication
(10) Pub. No.: US 2014/0122807 A1
(43) Pub. Date: May 1, 2014

(54) MEMORY ADDRESS TRANSLATIONS

(71) Applicant: HEWLETT-PACKARD DEVELOPMENT COMPANY, LP., Houston, TX (US)

(72) Inventors: Jichuan Chang, Sunnyvale, CA (US); Doe Hyun Yoon, San Jose, CA (US); Parthasarathy Ranganathan, San Jose, CA (US)

(73) Assignee: Hewlett-Packard Development Company, LP., Houston, TX (US)

(21) Appl. No.: 13/665,490

(22) Filed: Oct. 31, 2012

(51) Int. Cl. G06F 12/08

(52) U.S. Cl. 711/137; 711/118; 711/202; 711/E12.057

(57) ABSTRACT

Memory address translations are disclosed. An example memory controller includes an address translator to translate an intermediate memory address into a hardware memory address based on a function, the address translator to select the function based on at least a portion of the intermediate memory address, the intermediate memory address being identified by a processor. The example memory controller includes a cache to store the function in association with an address range of the intermediate memory sector, the intermediate memory address being within the intermediate memory sector. Further, the example memory controller includes a memory accesser to access a memory module at the hardware memory address.

### BACKGROUND

Memory bandwidth is often used as a measure of how much information can be exchanged between a memory and a processor or memory controller within a particular amount of time (e.g., 1 second). Memory bandwidth is typically a bottleneck to achieving high performance and/or efficiency in computing architectures.

### BRIEF DESCRIPTION OF THE DRAWINGS

FIG. 1 illustrates two example data layouts.

FIG. 2 is a diagram of an example system constructed in accordance with the teachings of this disclosure to map data in memory.

FIG. 3A is an example memory organization of an example cache of FIG. 2.

FIG. 3B is an example memory organization of an example memory module of FIG. 2.

FIG. 4 is a block diagram of an example memory controller of FIG. 2.

FIG. 5 is an example table that may be stored by a memory mapping function cache of FIGS. 2 and/or 4.

FIG. 6 is a flowchart representative of example machine-readable instructions that may be executed to implement the example memory controller of FIGS. 1 and/or 4 to map data within the example memory module of FIG. 2.

FIG. 7 is a flowchart representative of example machine-readable instructions that may be executed to implement the example memory controller of FIGS. 2 and/or 4 to access data stored in the example memory module of FIG. 2.

### DETAILED DESCRIPTION

Memory bandwidth and/or access times are bottlenecks to achieving higher performance and/or better efficiency in modern computing, such as, for example, central processing unit (CPU) architectures and/or graphics processing unit (GPU) architectures. Although technology and architecture advancements have been proposed to address these bottlenecks, the extra memory bandwidth gained from such proposals is often wasted due to mismatches between data access patterns and mapping of data in memory systems.

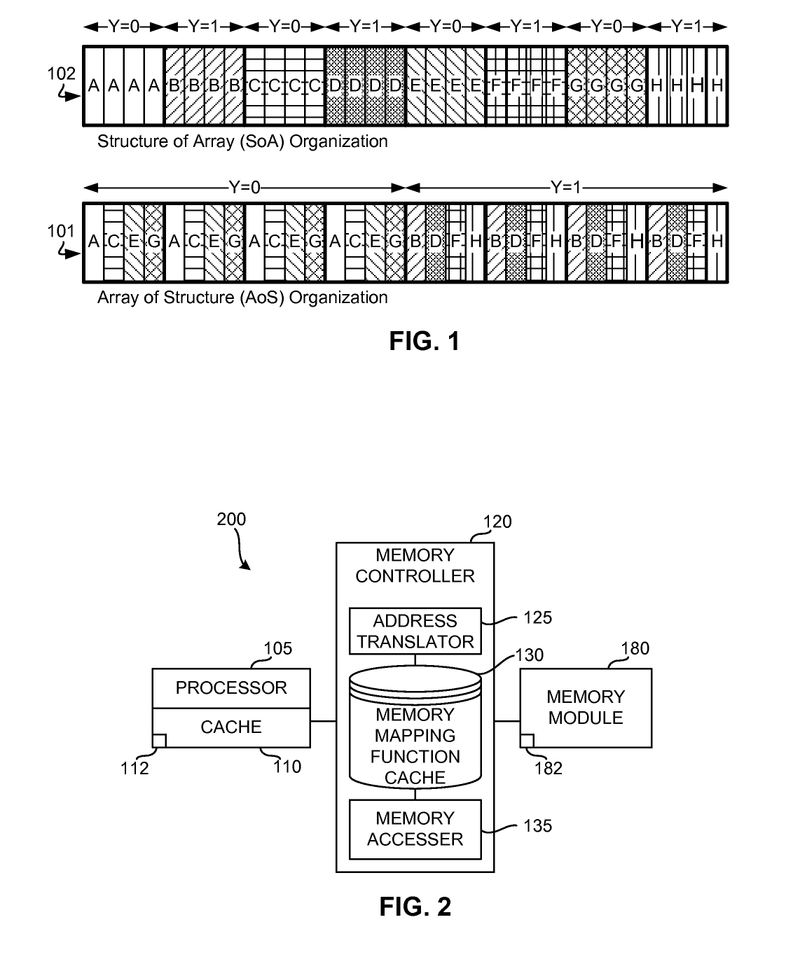

FIG. 1 illustrates two example types of memory layouts which may be used to organize data structures in memory. A data structure (e.g., an array, a hash, a record, a tuple, a set, a struct, an object, etc.) is a scheme for organizing data. When the data structure is stored in memory, it may be laid out in a variety of ways. Two types of layouts illustrated in the example of FIG. 1 are an Array of Structures (AoS) layout 101 and a Structure of Arrays (SoA) layout 102. For example, in a multi-dimensional grid of elements in which each element is a structure with multiple subfields, data may be laid out as an AoS [z][y][x][e] 101 (e.g., arranged by a first dimension “z”, a second dimension “y”, a third dimension “x”, and a fourth dimension “e”) or a SoA [e][z][y][x] 102 (e.g., ordered by the fourth dimension “e”, the first dimension “z”, the second dimension “y”, and the third dimension “x”). On a modern GPU using data access patterns particular to graphics processing, accessing data stored using the SoA layout 102 sometimes outperforms data stored using the AoS layout 101. When different access patterns are used, the AoS layout 101 sometimes outperforms the SoA layout 102. For other applications, the better performing data layouts could be data layouts different from the AoS layout 101 and/or the SoA layout 102. For example, grouping neighbor elements along dimensions x and y in a SoA-like structure ([z][y31:4][x31:4][e][y3:0][x3:0]) (e.g., ordered in a grouped approach) may, in some examples, outperform the AoS layout 101 and/or the SoA layout 102.

There are a number of challenges associated with organizing data and/or data architectures. For example, when data layout changes occur, the application code utilizing those data layouts must be changed and/or recompiled. Requiring code changes and/or recompilation may not be feasible and/or convenient with production software that undergoes rigorous testing and/or deployment procedures. In addition, high-efficiency data layouts may be memory module specific. That is, a data layout that may be efficient when implemented on one dynamic random-access memory (DRAM) configuration may be less efficient when used on another server with a different DRAM configuration. Accordingly, memory device organization and parameters such as memory channel(s), bank and/or row-buffer(s), etc. present challenges to implementing improved data access performance at the development and/or compilation stage before knowing specifics of the target hardware. Another challenge is that application code that leads to a particular data layout for achieving improved performance can also be complicated and hard to understand. Application code that is difficult to understand decreases the productivity of an application developer.

Example systems, methods, and articles of manufacture disclosed herein implement a programmable memory controller that uses one or more memory mapping function(s) to dynamically transform how data is organized (e.g., the data layout) in memory. Prior systems use static mapping tables such as translation lookaside buffer (TLB) tables that map logical memory addresses (e.g., virtual memory addresses) to corresponding physical memory addresses. Logical memory addresses correspond to a virtual memory space used by programs in, for example, a runtime environment to access data. Physical addresses are addresses within a memory map (e.g., a translation lookaside buffer) used in a cache to address memory locations. Physical addresses are perceived by the processor as the hardware location where data is stored. In prior systems, physical addresses also correspond directly to hardware memory locations. For example, a physical address for a DRAM chip in prior systems specifies a bank, a row, and a column of memory cells in the DRAM chip. In examples disclosed herein, such physical memory addresses are abstracted from hardware memory locations and are intermediate addresses in that they do not directly identify the hardware location of their corresponding data in physical memory. In examples disclosed herein, physical addresses are translated into hardware addresses using memory mapping function(s). In examples disclosed herein, physical memory addresses, such as those used in prior systems, are still employed by processor cache systems to address data in cache based on a virtual-to-physical memory map. Thus, such prior physical memory addresses are employed in examples disclosed herein as first-level physical addresses, for which processors use prior TLB techniques for translating from virtual memory addresses.

In examples disclosed herein, hardware addresses are addresses that operate as second-level physical addresses to indicate hardware-level memory locations. For example, a hardware address may represent a board-level location such as, for example, a memory channel, a memory bank, a memory row, and a memory column that specifies a memory cell in DRAM. In addition hardware addresses for types of memories other than DRAM (e.g., hardware addresses for SRAM, PCRAM, memristors, flash memory, etc.) may also be used in connection with examples disclosed herein.

For purposes of clarity, prior physical addresses such as those used in prior systems are referred to in examples disclosed herein as intermediate addresses (e.g., first-level physical addresses) used to address data in cache. In addition, hardware addresses (e.g., second-level physical addresses) are used in examples disclosed herein to refer to hardware-level memory locations of data stored in memories external to processors.

Using memory mapping function(s) as disclosed herein to translate intermediate addresses to hardware addresses is more efficient than using mapping tables (e.g., than using TLB tables as used for locating intermediate addresses of data in cache) because, for example, each intermediate address need not be individually stored for mapping to a respective hardware address. To further increase data access performance, examples disclosed herein can be used to adjust mapping function(s) based on different observed data access patterns. Accordingly, using examples disclosed herein, memory access patterns need not be changed by applications to improve data access performance. Instead, memory controllers can be implemented in accordance with examples disclosed herein to improve data access performance using different memory mapping functions based on observed data access patterns. By using data layouts in memory modules based on different memory access patterns, disclosed techniques can exploit memory parallelism and locality to increase performance and efficiency in modern CPU and GPU architectures.

FIG. 2 is a diagram of an example system 200 constructed in accordance with the teachings of this disclosure to map data in memory. The example system 200 of FIG. 2 includes a processor 105, a memory controller 120, and a memory module 180 (e.g., a physical memory).

The example processor 105 of the illustrated example of FIG. 2 is implemented by a hardware processor that executes instructions, but it could additionally or alternatively be implemented by an application specific integrated circuit(s) (ASIC(s)), programmable logic device(s) (PLD(s)) and/or field programmable logic device(s) (FPLD(s)), and/or other circuitry. In the illustrated example, the processor 105 includes and/or is in communication with a cache 110.

The example memory module 180 of the illustrated example may be implemented by any tangible machine-accessible storage medium for storing data such as, for example, NVRAM flash memory, magnetic media, optical media, etc. Data may be stored in the memory module 180 using any data format such as, for example, binary data, comma delimited data, tab delimited data, structured query language (SQL) structures, etc. While in the illustrated example the memory module 180 is illustrated as a single module, the memory module 180 may alternatively be implemented by any number and/or type(s) of memory modules.

The memory controller 120 of the illustrated example includes an example address translator 125, an example memory mapping function cache 130, and an example memory accesser 135. The example address translator 125 translates an intermediate memory address into a hardware memory address based on a function. The example address translator 125 selects the function based on the intermediate memory address (using part of the intermediate address to specify a data structure stored in hardware memory to which the intermediate address belongs). In the illustrated example, the intermediate memory address is in an intermediate memory sector in an intermediate memory map, and the address translator 125 uses a selected function to translate the intermediate address to a hardware memory address in a hardware sector of memory in a hardware memory map specifying module(s) and/or chip(s), and locations within such module(s) and/or chip(s). The example memory mapping function cache 130 stores the function in association with the intermediate memory sector as described below in connection with FIG. 5. The example memory accesser 135 accesses the memory module 180 at the hardware memory address identified by the address translator 125.

The example address translator 125 of the illustrated example of FIG. 2 is implemented by a processor executing instructions, but it could additionally or alternatively be implemented by an ASIC(s), PLD(s) and/or FPLD(s), and/or other circuitry. In the illustrated example, the address translator 125 receives an instruction to access data stored in the memory module 180 at an intermediate address. The example address translator 125 uses the intermediate address (or a portion thereof) and/or an arithmetic transformation of the intermediate address (or a portion thereof) to identify a function to be used for translating the intermediate memory address into a hardware memory address, and applies the function to the intermediate memory address. In the illustrated example, the function is implemented as a mathematical algorithm that translates the intermediate address. That is, the function does not need to be implemented using any look-up tables and/or translation lookaside buffers (TLBs), but instead uses arithmetic calculations. The association of the intermediate memory address(es) and the function used to translate such address(es) is/are stored in the example memory mapping function cache 130.

The example memory mapping function cache 130 of the illustrated example of FIG. 2 may be implemented by any tangible machine-accessible storage medium for storing data such as, for example, memory devices, NVRAM flash memory, magnetic media, and/or optical media. Data may be stored in the memory mapping function cache 130 using any data format such as, for example, binary data, comma delimited data, tab delimited data, structured query language (SQL) structures, etc. In the illustrated example, the memory mapping function cache 130 stores associations of intermediate memory sectors (e.g., intermediate memory addresses identified by an intermediate start address and an intermediate end address) and translation functions to be used to translate addresses within the intermediate memory sectors to corresponding hardware addresses within hardware memory sectors (e.g., data stored in the memory module 180). Example memory mapping function associations stored in the memory mapping function cache 130 are shown in FIG. 5.

In examples disclosed herein, data layout transformations performed by the memory controller 120 are implemented using one or more memory mapping function(s). In such examples, the address translator 125 executes a memory mapping function to translate an intermediate address into a hardware address in real time for a given subfield of a data structure. The hardware address is used to determine the memory device 180 (e.g., a particular memory module and/or a memory chip of a memory module) and memory address location in the memory device 180 to store and/or read data corresponding to a data access request. The example disclosed memory controller 120 supports multiple memory mapping functions. Each such function corresponds to a particular range and/or a sector of intermediate addresses. In the illustrated example, hardware memory addresses derived from translations using example memory mapping functions disclosed herein are not persisted in the memory controller as are hardware addresses in prior TLB tables. Instead, after the hardware memory address(es) is/are determined in real-time and used, the hardware memory address(es) are not necessarily stored for subsequent use, as such addresses can be obtained as needed by executing the corresponding function.

The example memory accesser 135 of the illustrated example of FIG. 2 is implemented by a processor executing instructions, but it could additionally or alternatively be implemented by an ASIC(s), PLD(s) and/or FPLD(s), and/or other circuitry. In some examples, the example memory accesser 135 is implemented by the same physical processor as the address translator 125. In the illustrated example, the example memory accesser 135 performs read and/or write operations based on the hardware memory address(es) identified by the address translator 125 to read data from and/or write data to the memory module 180. In some examples, the memory accesser 135 assembles retrieved data into a single block to provide requesting processor(s) with requested data assembled into the single block.

When the memory controller 120 writes data from cache 110 to the memory module 180 and/or other memory devices, the memory controller 120 translates one or more intermediate addresses corresponding to the cache 110 into one or more hardware addresses of the memory module 180 and/or other memory devices. In some examples, word-level dirty bits are used so that only dirty data is written through to the memory module 180. Word-level dirty bits indicate whether data stored at the word level has been modified while stored in the cache 110. If, for example, a word-level dirty bit indicates that data has not changed since it was stored in the cache 110 from the memory module 180, there is no need to perform a write operation to write-through the unchanged data to the memory (e.g., because the data is unchanged and, thus, it is still identically stored in the memory module 180).

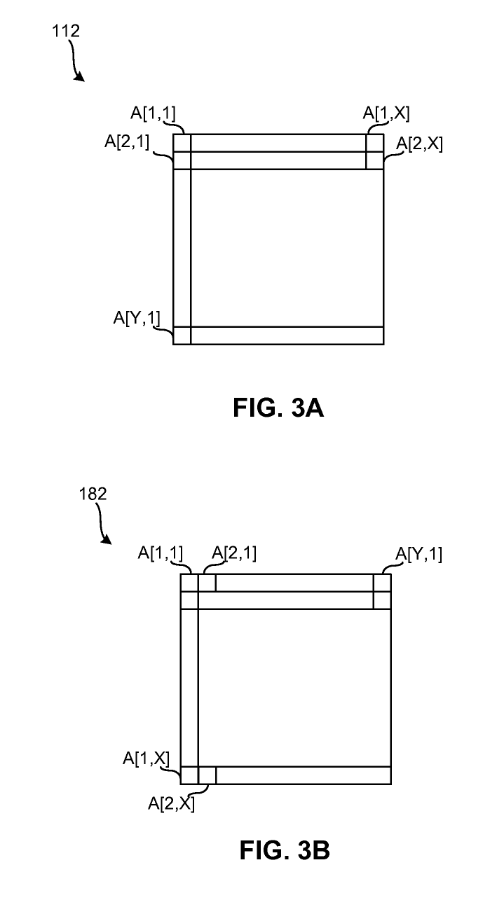

By way of example, the example cache 110 includes a block 112 of data that is structured as the processor 105 expects (e.g., potentially in an inefficient layout). An example of the data block 112 is shown in FIG. 3A. As shown in FIG. 3A, the memory is ordered in a traditional row (x) by column (y) structure. In addition, the example memory module 180 of FIG. 1 includes a block 182 that is structured using a translated layout. An example of the data block 182 is shown in FIG. 3B. As shown in FIG. 3B, the memory is ordered using column (y) by row (x) structure instead of a traditional row (x) by column (y) structure. In some examples, using a different arrangement (e.g., column by row instead of row by column) enables faster read and/or write operations. While FIG. 3B illustrates one example translated data layout arrangement, many other arrangements and/or combinations of arrangements may additionally or alternatively be used.

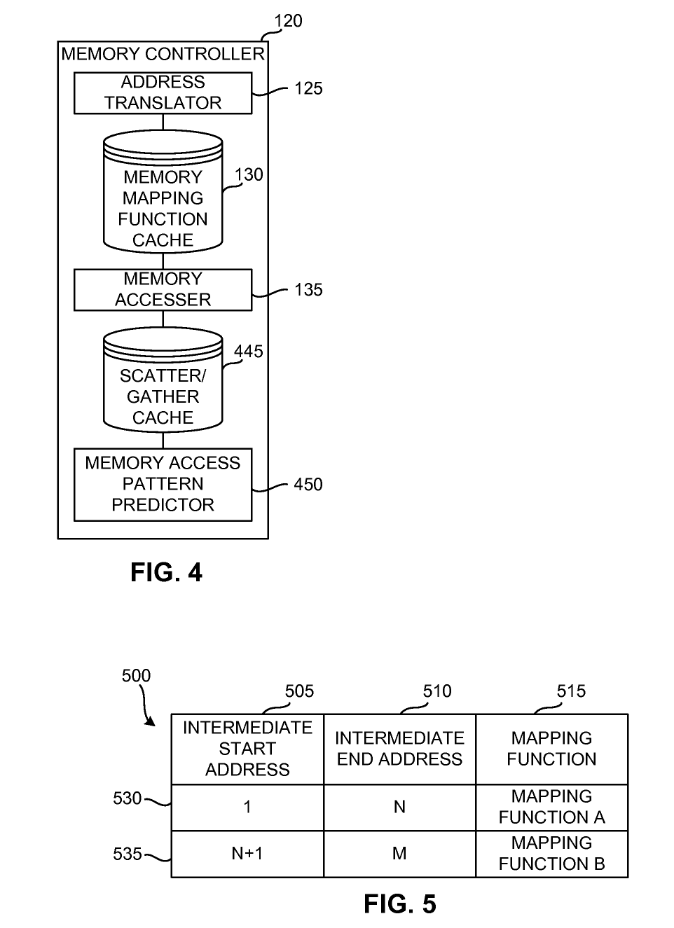

FIG. 4 is a block diagram of an additional implementation of the example memory controller 120 of FIG. 2. The example memory controller 120 of FIG. 4 includes the address translator 125, the memory mapping function cache 130, the memory accesser 135, a scatter/gather cache 445, and a memory access pattern predictor 450. The example address translator 125, the example memory mapping function cache 130, and the example memory accesser 135 translate intermediate memory address(es) to hardware memory address(es) using one or more memory mapping function(s).

After applying the memory mapping function(s), some data elements having contiguous intermediate addresses but that are not fetched in contiguous data accesses may be “scattered” (for writes) and “gathered” (for reads) to non-contiguous hardware addresses in the memory module 180. Referring to FIG. 1, data stored in logical memory (e.g., the cache 110) may be stored using an AoS layout 101. However, the memory controller 120 may identify, based on access patterns to the corresponding data in hardware memory (e.g., the memory module 180), that storing the data using an SoA layout 102 may be more efficient. For example, in the AoS layout 101, blocks are scattered throughout the memory (e.g., there is little to no locality for the blocks). By transforming the memory layout into an SoA layout 102, there is increased locality for the blocks. In some examples, having locality of the memory blocks affects the efficiency of different memory access patterns.

In a typical DRAM module, a memory row may include one or more cache lines. Reading one memory row from a memory buffer may fetch data that is/are scattered in hardware address space and stored in multiple locations of the hardware memory (e.g., in separate cache lines in the accessed memory row and/or in separate locations of a single cache line). When data that is not requested is part of a fetched cache line (or cache lines) having requested data scattered throughout, fetching a 64-byte block (e.g., a 64-byte cache line) from a memory row, in some examples, translates into multiple cache eviction and/or refill actions in the cache 110 because of the un-requested data fetched along with the scattered requested data. In such examples, word-level valid bits may be used to indicate “holes” (or non-present words) in different cache blocks so that data scattered across multiple sectors and/or addresses of hardware memory (e.g., stored on separate row buffers of memory) can be accessed and/or retrieved to return a complete cache line.

In some examples, disclosed techniques may be used to prefetch data that has not yet been requested but that is likely to be subsequently requested in connection with presently requested data. In such examples, when the memory controller 120 receives a read request, in addition to fetching the requested data (e.g., based on a demand request), the memory controller 120 performs a prefetch operation (e.g., a prefetch request) of one or more additional reads of other hardware memory addresses that are likely to be subsequently requested. The prefetch operations of the illustrated example collect data stored in memory that is likely to be subsequently requested based on prior or predicted access patterns. Because, in some examples, data stored on the memory is gathered into adjacent memory blocks, a single prefetch operation can capture multiple pieces of contiguously stored data that would otherwise be prefetched using multiple prefetch operations of scattered data. In some examples, gathered and/or scattered data is buffered in the scatter/gather cache 445 in a separate on-chip buffer of the memory controller 120 using the translated data layout.

The example scatter/gather cache 445 of the illustrated example of FIG. 4 may be implemented by any tangible machine-accessible storage medium for storing data such as, for example, storage devices, NVRAM flash memory, magnetic media, and/or optical media. Data may be stored in the scatter/gather cache 445 using any data format such as, for example, binary data, comma delimited data, tab delimited data, structured query language (SQL) structures, etc. In the illustrated example, the scatter/gather cache 445 stores data read as part of prefetch operations to satisfy data requests. Furthermore, the example scatter/gather cache 445 stores word-level data (not cache-lines).

The example memory controller 120 of FIGS. 2 and/or 4 enables data layouts to be changed in real time when the memory controller 120 and stored data are in use by software executing in a runtime environment by implementing different layouts using one or more corresponding memory mapping function(s). Dynamically changing data layouts in real time can be achieved with little or no negative impacts on development time, development costs, etc.

The example memory access pattern predictor 450 of the illustrated example of FIG. 4 is implemented by a processor executing instructions, but it could additionally or alternatively be implemented by an ASIC(s), PLD(s) and/or FPLD(s), and/or other circuitry. In some examples, the example memory access pattern predictor 450 is implemented by the same physical processor as the address translator 125 and/or the memory accesser 135. In the illustrated example, the memory access pattern predictor 450 monitors access patterns to a sector of hardware memory. Based on the memory access patterns, the memory access pattern predictor 450 derives and/or selects a memory mapping function to be used in association with one or more intermediate memory sectors storing data corresponding to the sector of hardware memory. In some examples, the memory access pattern predictor 450 reorganizes data stored in the hardware memory sector according to the selected memory mapping function and stores the memory mapping function in the memory mapping function cache 130 so that hardware addresses of future accesses to the memory 180 can be properly translated by the address translator 125.

FIG. 5 is an example table 500 that may be stored by the memory mapping function cache 130 of FIGS. 2 and/or 4. In the illustrated example, the table includes an intermediate start address column 505, an intermediate end address column 510, and an identifier of and/or description of an associated mapping function 515. In the illustrated example, the example table 500 includes a first mapping entry 530 and a second mapping entry 535. However, any number of entries containing any other information may additionally or alternatively be used. The first example mapping entry 530 of FIG. 5 specifies that the first intermediate memory sector starts at address one (e.g., an intermediate start address) and spans to address N (e.g., an intermediate end address). In the illustrated example, address N is different than address one. However, in some examples, address N is the same as address one, and the intermediate memory sector includes only one intermediate addressed storage location. The first example mapping entry 530 further defines that mapping function A should be used when the intermediate memory address is between address one and address N. The second example mapping entry 535 specifies that the second intermediate memory sector starts at address N plus one (N+1) (e.g., an intermediate start address) and spans to address M (e.g., an intermediate end address). The second example mapping entry 535 further specifies that mapping function B should be used when the intermediate memory address is between address N plus one (N+1) and address M. In the illustrated example, the mapping function A is different from the mapping function B. In this manner, the mapping function A can be used to increase the efficiencies of data access to a first intermediate sector of data based on data access patterns typically used when accessing data in the first intermediate sector, and the mapping function B can be used to increase the efficiencies of data accesses to a second intermediate sector of data based on data access patterns typically used when accessing data in the second intermediate sector.

While an example manner of implementing the memory controller 120 has been illustrated in FIGS. 2 and/or 4, one or more of the elements, processes and/or devices illustrated in FIGS. 2 and/or 4 may be combined, divided, re-arranged, omitted, eliminated and/or implemented in any other way. Further, the example address translator 125, the example memory mapping function cache 130, the example memory accesser 135, the example scatter/gather cache 445, the example memory access pattern predictor 450, and/or, more generally, the example memory controller 120 of FIGS. 2 and/or 4 may be implemented by hardware, software, firmware and/or any combination of hardware, software and/or firmware. Thus, for example, any of the example address translator 125, the example memory mapping function cache 130, the example memory accesser 135, the example scatter/gather cache 445, the example memory access pattern predictor 450, and/or, more generally, the example memory controller 120 of FIGS. 2 and/or 4 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example address translator 125, the example memory mapping function cache 130, the example memory accesser 135, the example scatter/gather cache 445, and/or the example memory access pattern predictor 450 are hereby expressly defined to include a tangible computer-readable storage medium such as a storage device (e.g., a memory) or a storage disc (e.g., a DVD, CD, Blu-ray) storing the software and/or firmware. Further still, the example memory controller 120 of FIGS. 2 and/or 4 may include one or more elements, processes and/or devices in addition to, or instead of, those illustrated in FIGS. 2 and/or 4, and/or may include more than one of any or all of the illustrated elements, processes and devices.

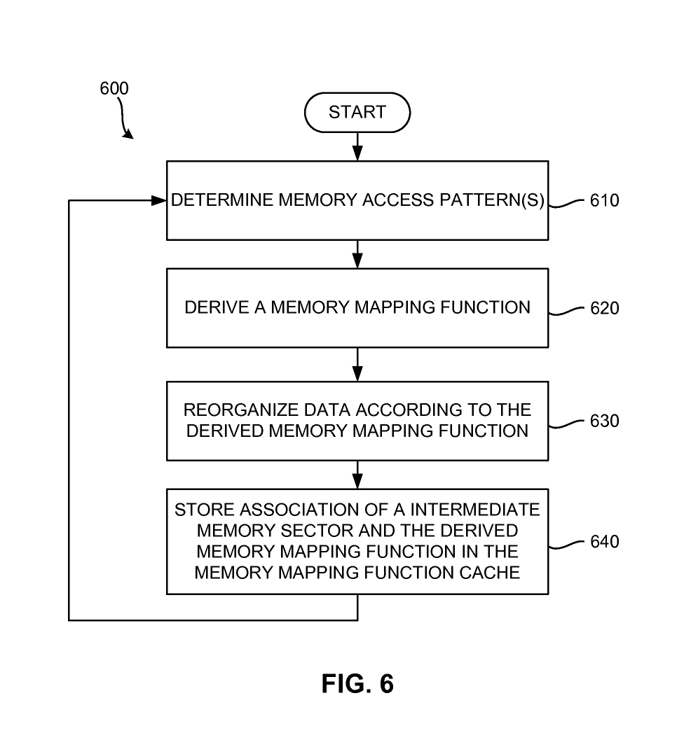

Flowcharts representative of example machine-readable instructions for implementing the memory controller 120 of FIGS. 2 and/or 4 are shown in FIGS. 6 and/or 7. In these examples, the machine-readable instructions comprise program(s) for execution by a processor of the memory controller 120 such as, for example, the address translator 125, the memory accesser 135, and/or the memory access pattern predictor. A processor is sometimes referred to as a microprocessor and/or a central processing unit (CPU). The program(s) may be embodied in software stored on a tangible computer-readable medium such as a CD-ROM, a floppy disk, a hard drive, a digital versatile disk (DVD), a Blu-ray disk, or a memory associated with the memory controller 120, but the entire program(s) and/or parts thereof could alternatively be executed by a device other than the memory controller 120 and/or embodied in firmware or dedicated hardware. Further, although the example programs are described with reference to the flowcharts illustrated in FIGS. 6 and/or 7, many other methods of implementing the example memory controller 120 may alternatively be used. For example, the order of execution of the blocks may be changed, and/or some of the blocks described may be changed, eliminated, or combined.

As mentioned above, the example processes of FIGS. 6 and/or 7 may be implemented using coded instructions (e.g., computer-readable instructions) stored on a tangible computer-readable storage medium such as a hard disk drive, a flash memory, a read-only memory (ROM), a compact disk (CD), a digital versatile disk (DVD), a cache, a random-access memory (RAM) and/or any other storage device or storage disc in which information is stored for any duration (e.g., for extended time periods, permanently, brief instances, for temporarily buffering, and/or for caching of the information). As used herein, the term tangible computer-readable storage medium is expressly defined to include any type of computer readable storage device or storage disc and to exclude propagating signals. Additionally or alternatively, the example processes of FIGS. 6 and/or 7 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer-readable medium is expressly defined to include any type of computer-readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 6 is a flowchart representative of example machine-readable instructions that may be executed to implement the example memory controller 120 of FIGS. 2 and/or 4 to optimize data stored in the example memory module 180 of FIG. 2.

The example process 600 of FIG. 6 may be executed continuously to ensure that memory access patterns are accurately monitored. The memory access pattern predictor 450 determines one or more access patterns from an intermediate memory sector to a hardware memory sector (block 610). Based on the identified memory access pattern(s), the memory access pattern predictor 450 derives a memory mapping function for use with accesses to the intermediate memory sector (block 620). In the illustrated example, the memory access pattern predictor 450 derives the memory mapping function. However, in some examples, the memory access pattern predictor 450 selects the memory mapping function from a list of known memory mapping functions (e.g., a function to transform from an AoS layout to an SoA layout, a function to transform from an SoA layout to an AoS layout, etc.) The memory access pattern predictor 450 reorganizes data stored in the hardware memory sector according to the selected memory mapping function (block 630). In some examples, the memory access pattern predictor 450 analyzes one or more criteria to determine whether to proceed with performing the re-organization. For example, the memory access pattern predictor 450 may determine that there is a period of inactivity in accessing the re-mapped memory sector and perform the reorganization during the period of inactivity. Reorganizing data stored in memory during a period of high activity may result in delays in accessing the data while reorganization is completed. In some examples, the memory access pattern predictor 450 identifies if the data stored in memory has recently been reorganized and waits a threshold amount of time before reorganizing the data in order to avoid constant re-organization of memory. In some examples, the memory access pattern predictor 450 determines an anticipated efficiency increase of the newly selected memory mapping function. The memory access pattern predictor 450 may, in some examples, reorganize the memory only when the anticipated efficiency increase is greater than an efficiency threshold. The memory access pattern predictor 450 stores an association of the derived memory mapping function and the intermediate memory sectors with which it is associated in the memory mapping function cache 130 (block 640). Control then proceeds to block 610 where memory access patterns continue to be monitored.

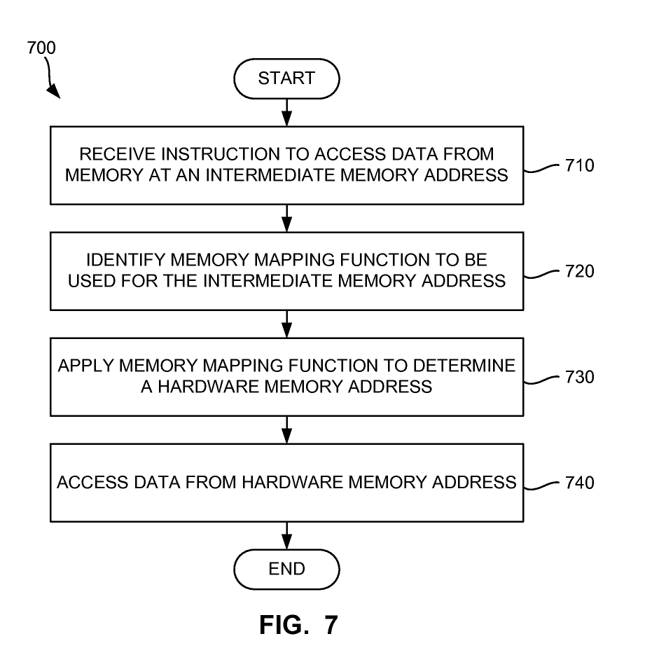

FIG. 7 is a flowchart representative of example machine-readable instructions that may be executed to implement the example memory controller 120 of FIGS. 2 and/or 4 to access data stored in the example memory module 180 of FIG. 2. The example process 700 begins when the memory controller 120 receives an instruction to access data (e.g., to read and/or to write) from the memory module 180 based on an intermediate memory address (block 710). The address translator 125 identifies a memory mapping function to be used for translating the intermediate memory address into a hardware memory address (block 720). The translator 125 applies the identified function to determine the hardware memory address associated with the intermediate memory address (block 730). In the illustrated example, the function is to determine the hardware address in real time. That is, the association of the intermediate memory address and the hardware memory address are not persisted in the memory controller 120. The memory accesser 135 then accesses (e.g., reads and/or writes) the memory module 180 at the hardware address to complete the memory access operation (block 740). The example process of FIG. 7 then ends.

Although certain example methods, apparatus, and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A memory controller comprising:
an address translator to translate an intermediate memory address into a hardware memory address based on a function, the address translator to select the function based on at least a portion of the intermediate memory address, the intermediate memory address being identified by a processor;
a cache to store the function in association with an address range of an intermediate memory sector, the intermediate memory address being within the intermediate memory sector; and
a memory accesser to access a memory module at the hardware memory address.

2. The memory controller as defined in claim 1, further comprising a memory access pattern predictor to monitor an access pattern of data accesses to a hardware memory sector, the memory access pattern predictor to select the memory mapping function based on the access pattern.

3. The memory controller as defined in claim 2, wherein the memory access pattern predictor is to reorganize data stored in the hardware memory sector according to a data layout for use with the memory mapping function, and the memory access pattern predictor is to store the memory mapping function in the cache in association with the intermediate memory sector.

4. The memory controller as defined in claim 1, wherein:
the intermediate memory address corresponds to an intermediate memory sector; and
the hardware memory address corresponds to a hardware memory sector stored on a memory module.

5. The memory controller as defined in claim 4, further comprising a scatter-gather cache to store data retrieved by at least one of a demand request or a prefetch request.

6. A method of accessing data stored in a memory, the method comprising:
identifying, with a memory controller, a function to be used for translating an intermediate memory address into a hardware memory address;
applying, with the memory controller, the function to determine the hardware memory address associated with the intermediate memory address, the association of the intermediate memory address and the hardware memory address not being persisted in a data structure; and
accessing the data from the hardware memory address.

7. The method as defined in claim 6, further comprising:
monitoring accesses to a sector of the memory; and
selecting the function from a plurality of different functions, the function to be used to translate between intermediate and hardware memory addresses to access the data in the sector of the memory.

8. The method as defined in claim 7, further comprising:
reorganizing the data stored in the sector of the memory according to a data layout for use with the function; and
associating the function with an intermediate address range of the sector of the memory.

9. The method as defined in claim 6, wherein the function is determined based on the intermediate memory address being located in an area of memory accessed using a data access pattern for which the function facilitates accessing data.

10. The method as defined in claim 6, wherein the function translates the intermediate memory address into two or more hardware addresses, and further comprising:
accessing the data from the two or more hardware memory address; and
assembling the data from the two or more hardware memory addresses.

11. The method as defined in claim 6, wherein the function is a mathematical function.

12. A tangible computer-readable storage medium comprising instructions which, when executed, cause a machine to at least:
identify a function to be used for translating an intermediate memory address into a hardware memory address;
apply the function to determine the hardware memory address associated with the intermediate memory address, the association of the intermediate memory address and the hardware memory address not being persisted in a data structure; and
access the data from the hardware memory address.

13. The computer-readable storage medium defined in claim 12, further comprising instructions which, when executed, cause the machine to at least:
monitor accesses to a sector of the memory; and
select the function from a plurality of different function, the function to be used to translate between intermediate and hardware memory addresses to access the data in the sector of the memory.

14. The computer-readable storage medium defined in claim 13, further comprising instructions which, when executed, cause the machine to at least:
reorganize the data stored in the sector of the memory according to a data layout for use with the function; and
associate the function with an intermediate address range of the sector of the memory.

15. The computer-readable storage medium defined in claim 12, wherein the function is determined based on the intermediate memory address being located in an area of memory accessed using a data access pattern for which the function facilitates accessing data.

16. The computer-readable storage medium defined in claim 12, wherein the function translates the intermediate memory address into two or more hardware addresses, and further comprising instructions which, when executed, cause the machine to at least:
access the data from the two or more hardware memory address; and
assemble the data from the two or more hardware memory addresses.

17. The computer-readable storage medium defined in claim 12, wherein the function is a mathematical function.
